(19) United States
(12) Patent Application Publication
(10) Pub. No.: US 2018/0276842 A1
(43) Pub. Date: Sep. 27, 2018

(54) SYSTEM AND METHOD FOR IMAGE BASED CONFIRMATION

(71) Applicant: BlackBerry Limited, Waterloo (CA)

(72) Inventors: Conrad Delbert SEAMAN, Ottawa (CA); Ryan Michael PARKER, Ottawa (CA); Stephen WEST, Manotick (CA)

(21) Appl. No.: 15/470,112

(22) Filed: Mar. 27, 2017

(51) Int. Cl. G06T 7/70

(52) U.S. Cl. CPC G06T 7/70; G06T 2207/10004; G06T 2207/30108

(57) ABSTRACT

A method at a computing device for replacing sensor data from a sensor that has failed, the method including receiving an indication at the computing device, that the sensor has failed; receiving image data from a location associated with the sensor; and using the image data to replace sensor data from the sensor that has failed.

### FIELD OF THE DISCLOSURE

The present disclosure relates to sensor devices, and in particular relates to sensor devices in which a central monitoring station may monitor sensor data.

### BACKGROUND

Sensor systems may include a plurality of sensor apparatuses operating remotely from a central monitoring station to provide remote sensor data to a management or monitoring hub. For example, one sensor system involves fleet management or cargo management systems. In fleet management or cargo management systems, sensors may be placed on a trailer, shipping container or similar product to provide a central station with information regarding the container. Such information may include, but is not limited to, information concerning the current location of the trailer or shipping container, the temperature inside the shipping container or trailer, whether the doors on the shipping container or trailer are closed, whether a sudden acceleration or deceleration event has occurred, the tilt angle of the trailer or shipping container, among other similar data.

In other cases, various fixed or mobile sensor apparatuses may have sensors that report data to a central controller. Examples may include any Internet of things devices, endpoints, home automation devices, medical equipment in hospital or home environments, inventory tracking devices, environmental monitoring devices, energy management devices, infrastructure management devices, among other options.

For each of these sensor systems, in some cases sensors on a sensor apparatus may fail. For example, a sensor may stop reporting data or may report erroneous data to the sensor apparatus, which may then be incapable of providing information to the central monitoring station or provide erroneous data to the central monitoring station. In other cases, sensor apparatuses may provide data to the central monitoring station that is unexpected, indicating that a potential situation may exist around or with the sensor apparatus. In such situations, the sensor may need to be replaced when the sensor apparatus is next in a location that allows for such servicing. However, this may involve a lengthy delay in which no sensor data is available. In other cases, personnel may need to be physically dispatched to monitor or verify unexpected sensor data. This may prove time consuming and costly.

### BRIEF DESCRIPTION OF THE DRAWINGS

The present disclosure will be better understood with reference to the drawings, in which:

FIG. 1 is a block diagram of an example image sensor apparatus;

FIG. 2 is a block diagram showing an example system having servers and sensor apparatuses;

FIG. 3 is a process diagram showing the capturing and forwarding of image data from a sensor apparatus;

FIG. 4 is a process diagram showing a process at a server for replacing sensor data based on image data;

FIG. 5 is a process diagram showing a process at a server for verifying sensor data by asking for image data and using the image data for the verification;

FIG. 6 is a process diagram showing a process at a server for verifying sensor data by receiving image data with the sensor data and using the image data for the verification; and

FIG. 7 is a block diagram of an example server capable of being used with the embodiments of the present disclosure.

### DETAILED DESCRIPTION

The present disclosure provides a method at a computing device for replacing sensor data from a sensor that has failed, the method comprising: receiving an indication at the computing device, that the sensor has failed; receiving image data from a location associated with the sensor; and using the image data to replace sensor data from the sensor that has failed.

The present disclosure further provides a computing device configured for replacing sensor data from a sensor that has failed, the computing device comprising: a processor; and a communications subsystem, wherein the computing device is configured to: receive an indication that the sensor has failed; receive image data from a location associated with the sensor; and use the image data to replace sensor data from the sensor that has failed.

The present disclosure further provides a computer readable medium for storing instruction code, which, when executed by a processor of a computing device configured for replacing sensor data from a sensor that has failed, causes the computing device to: receive an indication that the sensor has failed; receive image data from a location associated with the sensor; and use the image data to replace sensor data from the sensor that has failed.

In the embodiments described herein, a sensor apparatus may be any apparatus that is capable of providing data or information from sensors associated with the sensor apparatus to a central monitoring or control station. Sensors associated with the sensor apparatus may either be physically part of the sensor apparatus, for example a built-in global positioning system (GPS) chipset, or may be associated with the sensor apparatus through short range communications. For example, a tire pressure monitor may provide information through a Bluetooth™ Low Energy (BLE) signal from the tire to the sensor apparatus. Other examples are possible.

A central monitoring station may be any server or combination of servers that are remote from the sensor apparatus. The central monitoring station can receive data from a plurality of sensor apparatuses, and in some cases may have software to monitor such data and provide alerts to operators if the data is outside of predetermined boundaries.

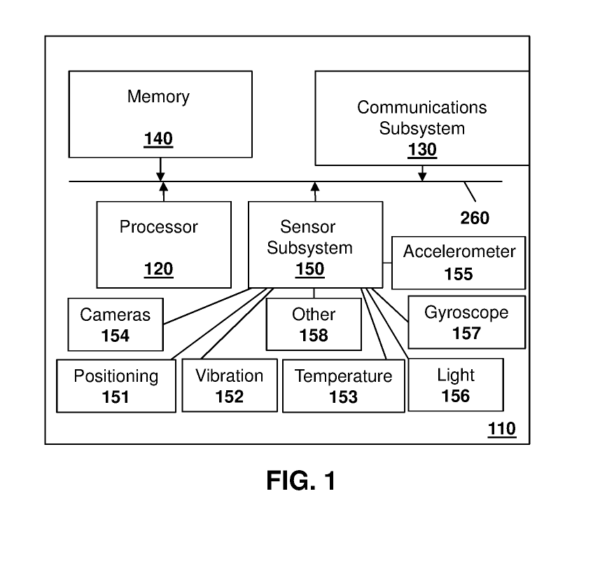

One sensor apparatus is shown with regard to FIG. 1. The sensor apparatus of FIG. 1 is however merely an example and other sensor apparatuses could equally be used in accordance with the embodiments of the present disclosure.

Reference is now made to FIG. 1, which shows an example sensor apparatus 110. Sensor apparatus 110 can be any computing device or network node. Such computing device or network node may include any type of electronic device, including but not limited to, mobile devices such as smartphones or cellular telephones. Examples can further include fixed or mobile devices, such as internet of things devices, endpoints, home automation devices, medical equipment in hospital or home environments, inventory tracking devices, environmental monitoring devices, energy management devices, infrastructure management devices, vehicles or devices for vehicles, fixed electronic devices, among others.

Sensor apparatus 110 comprises a processor 120 and at least one communications subsystem 130, where the processor 120 and communications subsystem 130 cooperate to perform the methods of the embodiments described herein. Communications subsystem 130 may, in some embodiments, comprise multiple subsystems, for example for different radio technologies.

Communications subsystem 130 allows sensor apparatus 110 to communicate with other devices or network elements. Communications subsystem 130 may use one or more of a variety of communications types, including but not limited to cellular, satellite, Bluetooth™, Bluetooth™ Low Energy, Wi-Fi, wireless local area network (WLAN), near field communications (NFC), Zigbee, wired connections such as Ethernet or fiber, among other options.

As such, a communications subsystem 130 for wireless communications will typically have one or more receivers and transmitters, as well as associated components such as one or more antenna elements, local oscillators (LOs), and may include a processing module such as a digital signal processor (DSP). As will be apparent to those skilled in the field of communications, the particular design of the communication subsystem 130 will be dependent upon the communication network or communication technology on which the sensor apparatus is intended to operate.

Processor 120 generally controls the overall operation of the sensor apparatus 110 and is configured to execute programmable logic, which may be stored, along with data, using memory 140. Memory 140 can be any tangible, non-transitory computer readable storage medium, including but not limited to optical (e.g., CD, DVD, etc.), magnetic (e.g., tape), flash drive, hard drive, or other memory known in the art.

Alternatively, or in addition to memory 140, sensor apparatus 110 may access data or programmable logic from an external storage medium, for example through communications subsystem 130.

In the embodiment of FIG. 1, sensor apparatus 110 may utilize a plurality of sensors, which may either be part of sensor apparatus 110 in some embodiments or may communicate with sensor apparatus 110 in other embodiments. For internal sensors, processor 120 may receive input from a sensor subsystem 150.

Examples of sensors in the embodiment of FIG. 1 include a positioning sensor 151, a vibration sensor 152, a temperature sensor 153, one or more image sensors 154, accelerometer 155, light sensors 156, gyroscopic sensors 157, and other sensors 158. Other sensors may be any sensor that is capable of reading or obtaining data that may be useful for sensor apparatus 110. However, the sensors shown in the embodiment of FIG. 1 are merely examples, and in other embodiments different sensors or a subset of sensors shown in FIG. 1 may be used.

Communications between the various elements of sensor apparatus 110 may be through an internal bus 160 in one embodiment. However, other forms of communication are possible.

Sensor apparatus 110 may be affixed to any fixed or portable platform. For example, sensor apparatus 110 may be affixed to shipping containers, truck trailers, truck cabs in one embodiment. In other embodiments, sensor apparatus 110 may be affixed to any vehicle, including motor vehicles (e.g., automobiles, cars, trucks, buses, motorcycles, etc.), aircraft (e.g., airplanes, unmanned aerial vehicles, unmanned aircraft systems, drones, helicopters, etc.), spacecraft (e.g., spaceplanes, space shuttles, space capsules, space stations, satellites, etc.), watercraft (e.g., ships, boats, hovercraft, submarines, etc.), railed vehicles (e.g., trains and trams, etc.), and other types of vehicles including any combinations of any of the foregoing, whether currently existing or after arising, among others.

In other cases, sensor apparatus 110 could be carried by a user.

In other cases, sensor apparatus 110 may be affixed to stationary objects including buildings, lamp posts, fences, cranes, among other options.

Such sensor apparatus 110 may be a power limited device. For example sensor apparatus 110 could be a battery operated device that can be affixed to a shipping container or trailer in some embodiments. Other limited power sources could include any limited power supply, such as a small generator or dynamo, a fuel cell, solar power, among other options.

In other embodiments, sensor apparatus 110 may utilize external power, for example from the engine of a tractor pulling the trailer, from a land power source for example on a plugged in recreational vehicle or from a building power supply, among other options.

External power may further allow for recharging of batteries to allow the sensor apparatus 110 to then operate in a power limited mode again. Further, recharging methods may also include other power sources, such as, but not limited to, solar or vibration charging.

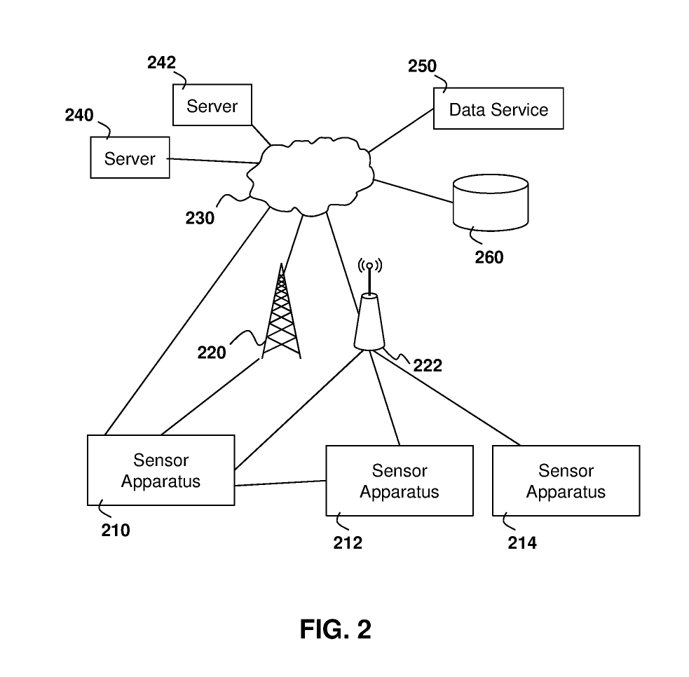

The sensor apparatus from FIG. 1 may be used in a variety of environments. One example environment in which the sensor apparatus may be used is shown with regard to FIG. 2.

Referring to FIG. 2, three sensor apparatuses, namely sensor apparatus 210, sensor apparatus 212, and sensor apparatus 214 are provided.

In the example of FIG. 2, sensor apparatus 210 may communicate through a cellular base station 220 or through an access point 222. Access point 222 may be any wireless communication access point.

Further, in some embodiments, sensor apparatus 210 could communicate through a wired access point such as Ethernet or fiber, among other options.

The communication may then proceed over a wide area network such as Internet 230 and proceed to servers 240 or 242.

Similarly, sensor apparatus 212 and sensor apparatus 214 may communicate with servers 240 or server 242 through one or both of the base station 220 or access point 222, among other options for such communication.

In other embodiments, any one of sensors 210, 212 or 214 may communicate through satellite communication technology. This, for example, may be useful if the sensor apparatus is travelling to areas that are outside of cellular coverage or access point coverage.

In other embodiments, sensor apparatus 212 may be out of range of access point 222, and may communicate with sensor apparatus 210 to allow sensor apparatus 210 to act as a relay for communications.

Communication between sensor apparatus 210 and server 240 may be one directional or bidirectional. Thus, in one embodiment sensor apparatus 210 may provide information to server 240 but server 240 does not respond. In other cases, server 240 may issue commands to sensor apparatus 210 but data may be stored internally on sensor apparatus 210 until the sensor apparatus arrives at a particular location. In other cases, two-way communication may exist between sensor apparatus 210 and server 240.

Server 240 may, for example, be a fleet management centralized monitoring station. In this case, server 240 may receive information from sensor apparatuses associated with various trailers or cargo containers, providing information such as the location of such cargo containers, the temperature within such cargo containers, any unusual events including sudden decelerations, temperature warnings when the temperature is either too high or too low, among other data. The server 240 may compile such information and store it for future reference. It may further alert an operator. For example, a sudden deceleration event may indicate that a trailer may have been in an accident and the operator may need to call emergency services and potentially dispatch another tractor to the location. Other examples are possible.

In the embodiment of FIG. 2, servers 240 and 242 may further have access to third-party information or information from other servers within the network. For example, a data services provider 250 may provide information to server 240. Similarly, a data repository or database 260 may also provide information to server 240.

For example, data services provider 250 may be a subscription based service used by server 240 to obtain current road and weather conditions.

Data repository or database 260 may for example provide information such as image data associated with a particular location, aerial maps, or other such information.

The types of information provided by data service provider 250 or the data repository or database 260 is not limited to the above examples and the information provided could be any data useful to server 240.

Using the above sensor apparatus, or other similar sensor apparatuses, in some cases visual verification or substitution of sensor data may be useful. For example, as described below, in some cases if a sensor fails, the data provided by that sensor may be substituted with visual data that could then provide similar results to a server 240. In accordance with other embodiments described below, the visual data provided by the sensor apparatus may be used to verify other sensor readings, such as a door opening event, a high temperature event, a trailer tilt event, among other options.

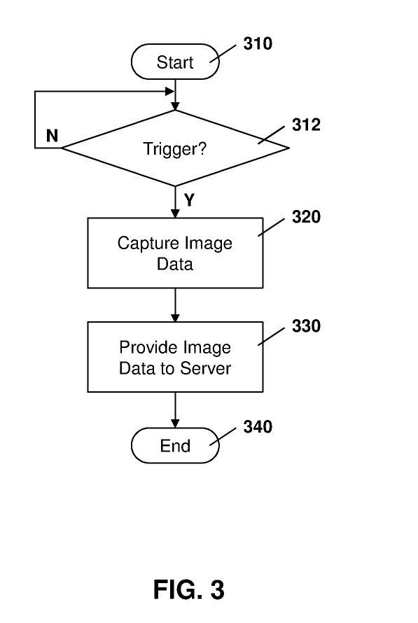

Reference is now made to FIG. 3. The embodiment of FIG. 3 shows a generalized process in accordance with the embodiments of the present disclosure. Specifically, the process of FIG. 3 starts at block 310 and proceeds to block 312 in which a check is made to determine whether a trigger has been received at the sensor apparatus.

The trigger of block 312 may be either an internal, external or combination trigger. In particular, an internal trigger may be the detection of a sensor failure for a sensor associated with the sensor apparatus. Thus, for example, if the GPS chipset stops reporting the current location of the sensor apparatus, a processor on the sensor apparatus may detect the lack of response from the positioning sensor and may cause trigger 312. Similarly, the failure of other sensors associated with the sensor apparatus may be detected by a processor of the sensor apparatus.

Trigger 312 may further be caused by sensor readings that are outside of the threshold as determined by a processor on the sensor apparatus. Thus, if a deceleration event exceeds a threshold, if the tilt of the trailer exceeds a certain angle, if the temperature detected by a temperature sensor is higher or lower than threshold values, among other examples, then the trigger at block 312 may be met.

In still further embodiments, the trigger 312 may be based on a pattern of sensor readings, where such pattern may be indicative of a sensor problem or may indicative of a condition for which an image may be useful. The pattern may be defined in some embodiments, or may be learned, for example through a machine learning algorithm, in other embodiments. For example, such problem may be that a sensor is reporting data that is becoming more and more erroneous. In other cases, the condition may be a real-world condition for which an image may be useful. For example, if a trailer has a tilt sensor with a threshold value of 30° for taking a picture, if in a short time the tilt of the trailer goes from 20°, to 22°, to 24°, this may cause a processor on the sensor apparatus or server to conclude that the tilt of the trailer is heading towards the threshold and cause an image to be taken. Other examples are possible.

In other embodiments, the trigger may be external to the sensor apparatus. For example, the trigger may be a message that is received from a server such as server 240 from FIG. 2. For example, such trigger may be provided if server 240 detects anomalous data.

A combination trigger may include the detection of sensor data falling outside of a set range internally, along with a confirmation from a server 240 that image data is needed.

Other examples are possible.

If the trigger at block 312 is not met, then the process proceeds back to block 312 and continues to loop until a trigger condition is met.

Once the trigger condition is met, the process proceeds to block 320 in which image data is captured. Image data may include, but is not limited to, video data, picture data, infrared scans, among other options for image data.

Once the image data is captured at block 320, the process proceeds to block 330. At block 330, the image data is provided to the server such as server 240 from FIG. 2. In some cases, image data provided in block 330 may include other information, such as sensor readings, the reasons for providing the information such as the trigger threshold that was met, among other options. Further, in some cases the device identifier may be provided.

For example, in Table 1 below, a message from sensor apparatus 210 to server 240 may include various information.

TABLE 1
Example image capture data

Event ID
Device ID
Position of Capturing device
Other sensor information
Trigger data
Image data

In Table 1, the event identifier may be an internal identifier assigned by the sensor apparatus to an event. It may further be an identifier received from the server 240 if the trigger was an external trigger. Event identifier may be used to internally track an event at server 240, for example.

A device identifier may further be provided to server 240. The device identifier may uniquely identify the sensor apparatus to the server 240, and may be set at sensor apparatus when the sensor apparatus is deployed in some embodiments.

The position of the sensor apparatus may be provided if available to aid server 240 in locating the sensor apparatus.

Other sensor information may include temperature readings, humidity readings, tilt readings, door event readings, among other options.

The trigger data may include the reason that the trigger event occurred and the reason why image data is being provided to the server 240. For example, it may include a code specifying that a particular sensor has stopped working, or may indicate that data is outside of a set range for a particular sensor, among other options.

The data provided in Table 1 is merely one example of a message that can accompany image data. In some cases, image data may not have any other data associated with it. In other cases, a subset of the data provided in Table 1 is provided. In still further cases, different data to that provided in the example message of Table 1 is provided.

In FIG. 3, from block 330 the process proceeds to block 340 and ends.

From a server perspective, the server may react differently depending on whether the sensor has failed completely or whether the data from the sensor provides a value that is outside of a threshold range. Examples of each are provided below.

Sensor Failure

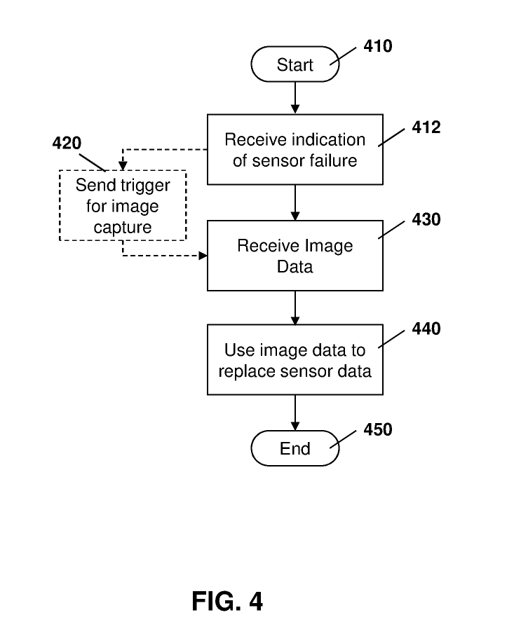

In accordance with one embodiment of the present disclosure, the server may try to recover from the failure of a sensor on a sensor apparatus. In particular, reference is now made to FIG. 4, which shows a process for the recovery of data for a sensor that has failed. While the example below details recovery of data at a server, in some cases data recovery may also or instead be done at the sensor apparatus.

The process of FIG. 4 starts at block 410 and proceeds to block 412 in which the server receives an indication of sensor failure from a sensor apparatus. Such indication may be either a message explicitly providing that the sensor has failed, a pattern or erroneous readings, or lack of data for a sensor on the sensor apparatus, for example.

Responsive to the receipt of the indication, in one embodiment the server may send a trigger for image capture back to the sensor apparatus, shown by block 420. However, in other embodiments block 420 may be unnecessary if the sensor apparatus itself has detected that the sensor has failed and therefore provides the image data without such trigger.

From blocks 412 or 420, the process proceeds to block 430 in which the server receives the image data from the sensor apparatus. The image data may include additional information associated with it, including a device identifier for the sensor apparatus that is capturing image data, along with other sensor information if available.

From block 430 the process proceeds to block 440 in which the image data is used by the server 240 to attempt to replace the sensor data. Various options exist for the recovery at block 440.

For example, if the indication at block 412 provided that the positioning sensor failed, then the sensor apparatus may be unable to provide its location. In this case, the image data received at block 430 could be one or more pictures taken at the location of the sensor apparatus and could be used, either based on a single image or plurality of images, to try to determine the position of the sensor apparatus.

For example, a series of photos may be taken, for example one photo every 10 seconds for a minute, in the hopes of capturing a street sign. An algorithm at server 240 may look for street signs to find the location of sensor apparatus.

In another example, the algorithm on server 240 may look for landmarks. Such landmarks could be distinctive buildings, mountains, statues, monuments, among other examples. Such landmarks may be used to identify the position of the sensor apparatus or narrow the possible locations for the sensor apparatus.

In other cases, the scene from the photos may be compared with data from a data repository 260 to attempt to find the location. For example, in the case of a trailer sensor, the trucking company may have in the past stored visual images of typical truck routes run from that company. The server may then compare images from the database with the images being received from the sensor apparatus to try to pinpoint the location of the trailer.

In other embodiments, the server 240 may retrieve information from a data service 250. For example, with a GPS failure, the images may be compared to a Google Street View™ image repository to attempt to locate the sensor apparatus.

In the examples above, various external factors could also be used to narrow the search scope. For example, the position that a last device check-in occurred, the cellular base station that the device is using to communicate, the intended route for the vehicle, among other factors could be used to narrow the search scope in order to allow for faster determination of the location of the sensor apparatus.

In other embodiments, an operator of server 240 may also be able to use the image data to narrow the location of the sensor apparatus. For example, if the sensor apparatus is located within a shipping yard, an operator familiar with the shipping yard could use the image data to pinpoint the location of the sensor apparatus.

In other cases, other sensors may fail. For example, if a tilt sensor on a sensor apparatus fails, then an image could be used to calculate the angle of the sensor apparatus by comparing a ground plane or a vertical plane from building, with the angle of the image being taken.

In other cases, if a door close sensor has failed, an image from the sensor apparatus may be used to check if the door is closed or open. For example, if the sensor apparatus has both internal and external image detectors, pointing into and out of the trailer, if the internal camera is showing light from the outside, then the door may still be open.

Similarly, if an accelerometer has failed, a series of images received as image data in block 430 could be used to determine whether or not the sensor apparatus is moving or stationary and further may also be used to indicate the rate of a movement in some embodiments by comparing successive images if such successive images are taken at evenly spaced intervals.

Other options or examples of sensor recovery would be apparent to those skilled in the art having regard to the present disclosure.

If the image data can be used for sensor recovery, the faulty sensor data may be replaced at server 240 with the data determined at block 440.

The process then proceeds to block 450 and ends.

Sensor Verification

In a further embodiment, rather than a sensor failing, a sensor may provide readings that are outside of the threshold for that sensor, or may provide a pattern of readings that may indicate to a processor of the sensor apparatus or server that the threshold will soon be passed. For example, a temperature sensor may indicate that the temperature within a trailer needs to stay between 3° and 5° C. If sensor readings are higher or lower than these thresholds, this may cause a trigger either at server 240 or at sensor apparatus 210. In other cases, a door sensor may detect a door opening event or a vibration sensor may detect the entry of a person or machine into a trailer to indicate a loading or unloading event and this may be a trigger. In other cases, readings from one or a combination of sensors provide an indication of a real-world issue for which an image is useful. The indication may be predefined or may be learned, for example though machine learning.

Other examples may include a sudden deceleration detected by an accelerometer, positioning sensors indicating that the trailer is outside of a geo-cached area, a tilt sensor indicating that the trailer has exceeded a certain tilt angle, among other options.

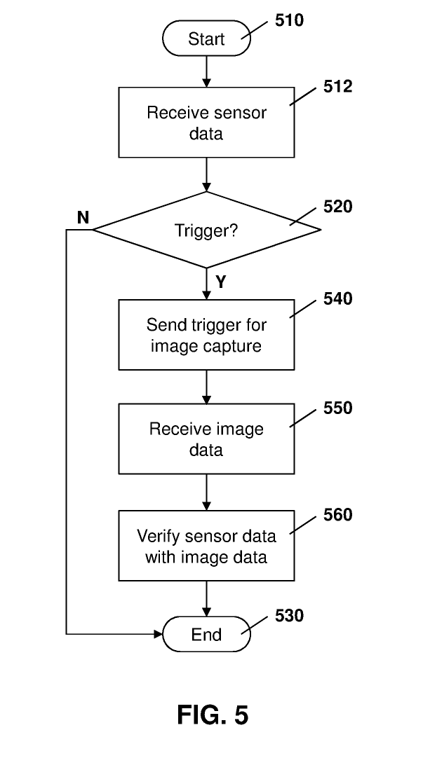

Reference is now made to FIG. 5, which shows an embodiment of a process in which a server 240 may detect that sensor data is outside of the threshold. In particular, the process of FIG. 5 starts at block 510 and proceeds to block 512 in which the server 240 receives sensor data.

The process then proceeds to block 520 to determine whether or not the sensor data meets a trigger condition. The check at block 520 may, as indicated above, provide a trigger when the sensor data is outside of a range or threshold set at server 240.

From block 520, if the data is within the predetermined range or threshold, then the process proceeds to block 530 and ends.

Conversely, if the data is within the trigger range, indicating that the data falls outside of a threshold or range of the data expected, the process may proceed to block 540. At block 540 the server 240 may send a message to sensor apparatus 210 asking for images to be captured. The message at block 540 may include various details, including for example the period that each photograph for a successive set of photographs should be taken. For example, the message may ask for a photograph every five seconds for the next two minutes. The message may further include a duration for the image capture. Thus the image capture may only last for the next two minutes or five minutes in some examples.

The message may further ask for video to be taken.

Further, the message sent at block 540 may ask for reporting from other sensors on sensor apparatus in some embodiments.

From block 540 the process proceeds to block 550 in which the requested image data is received. As indicated above, the requested image data may be one photograph, a series of photographs, or may be video, infrared imaged data, among other options.

From block 550 the process proceeds to block 560 in which the sensor data is verified with the visual data received at block 550. In particular, the verification of sensor data may be done automatically at server 240 or may require manual verification by an operator of server 240.

With regard to automatic verification, one example might be the door open sensor triggering an alert. This may then be verified automatically on server 240 by detecting whether an internally facing camera shows the inside of the trailer or shows an external image.

Further, an automatic verification may include an image when a tilt sensor exceeds a certain angle. For example, during a truck roll over, the tilt sensor may indicate that the trailer is at 90° to the road. An image capture may verify that the orientation of such image is also at 90° to the road and therefore that the tilt sensor is accurate.

Further, if bad data is being provided from a position sensor such as a global positioning system, then the verification at block 560 may include accessing databases of images to verify the location of the sensor apparatus with expected images for the reported position.

Manual verification may include an operator intervening, for example, during a loading or unloading event. Thus, when a trailer detects a door open event it can further look for vibration or use other means of detecting ongoing movement inside a container. Based on the movement, the sensor apparatus could take photos. Between a door open and a door close event the use of photos or short videos may enable an operator to confirm which goods were removed from the trailer and at which location. The same process, but in reverse, could work for loading. Such sensor readings and image capture may help prevent theft, ensure timely delivery and determine and provide correction for delivery errors more quickly.

The automatic or manual sensor verification may also be applicable to temperature sensors. For example, if a temperature sensor shows a spike or drop in temperature that may cause goods to spoil, image data may show a door being left open, ice melting, among other options and may enable an operator of server 240 to verify the temperature sensor without sending an inspector to the trailer site.

Other automatic or manual verification techniques would be apparent to those skilled in the art having regard to the present disclosure.

From block 560, the process proceeds to block 530 and ends.

In further embodiments, the threshold detection for sensor data may be built into the sensor apparatus 210. In this case, the processor on sensor apparatus 210 may detect that the sensor data being read is outside of the range or thresholds specified and may automatically provide the image data to server 240. In this case, blocks 520 and 540 of FIG. 5 may be unnecessary.

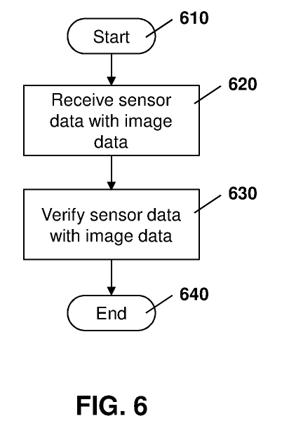

Specifically, reference is made to FIG. 6. In the embodiment of FIG. 6, a process at a server 240 is shown, in which the sensor data is sent with an image from the sensor apparatus 210.

Specifically, the process of FIG. 6 starts at block 610 and proceeds to block 620 in which the server 240 receives sensor data along with image data.

The process may then proceed to block 630 and verify the sensor data with the image data. Again, as with block 560, the verification at block 630 may be automatic or manual and depend on the type of sensor that has reported the data that is outside of the threshold.

From block 630 the process proceeds to block 640 and ends.

While the embodiments of FIGS. 5 and 6 detail sensor verification at a server, in some cases verification could be done at the sensor apparatus itself. For example, the sensor apparatus may store a database or repository of images, or may be capable of image processing to verify sensor readings with image data.

The image verification may therefore be used to either compensate for failed sensors or to verify sensor readings that fall outside of a range or threshold.

Such visual indications may be used for other verification purposes as well. For example, in trailer leasing, restrictions may be placed on trailer use. For example, such trailer may be used only on certain areas, may only be driven so far, may be used for only transporting certain types of products or may be restricted from being used for storage. Visual confirmation that such restrictions are being complied with could be valuable for trailer leasing companies.

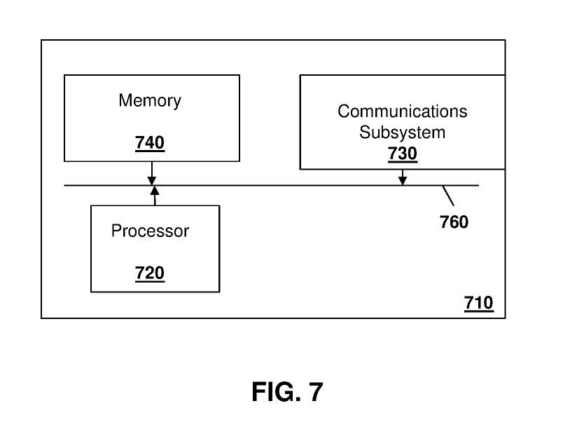

One example of a simplified server that can be used with the embodiments above is shown with regard to FIG. 7.

In FIG. 7, server 710 includes a processor 720 and a communications subsystem 730, where the processor 720 and communications subsystem 730 cooperate to perform the methods of the embodiments described herein.

Processor 720 is configured to execute programmable logic, which may be stored, along with data, on server 710, and shown in the example of FIG. 7 as memory 740. Memory 740 can be any tangible, non-transitory computer readable storage medium, such as optical (e.g., CD, DVD, etc.), magnetic (e.g., tape), flash drive, hard drive, or other memory known in the art.

Alternatively, or in addition to memory 740, server 710 may access data or programmable logic from an external storage medium, for example through communications subsystem 730.

Communications subsystem 730 allows server 710 to communicate with other devices or network elements.

Communications between the various elements of server 710 may be through an internal bus 760 in one embodiment. However, other forms of communication are possible.

The embodiments described herein are examples of structures, systems or methods having elements corresponding to elements of the techniques of this application. This written description may enable those skilled in the art to make and use embodiments having alternative elements that likewise correspond to the elements of the techniques of this application. The intended scope of the techniques of this application thus includes other structures, systems or methods that do not differ from the techniques of this application as described herein, and further includes other structures, systems or methods with insubstantial differences from the techniques of this application as described herein.

1. A method at a computing device for replacing sensor data from a sensor that has failed, the method comprising:
receiving an indication at the computing device, that the sensor has failed;
receiving image data from a location associated with the sensor; and
using the image data to replace sensor data from the sensor that has failed.

2. The method of claim 1, wherein the computing device is a server, and wherein the sensor is on a remote sensor apparatus reporting to the server.

3. The method of claim 1, wherein the sensor that has failed is a positioning sensor, and wherein the using the image data comprises identifying location data within the image data.

4. The method of claim 3, wherein the location data is at least one data item selected from the group including street name information; landmark information; monument information; or building information.

5. The method of claim 1, wherein the sensor that has failed is a positioning sensor, and wherein the image data is compared to a database of images correlated to location data.

6. The method of claim 5, wherein the images in the database used for comparing are narrowed based on information about the sensor.

7. The method of claim 6, wherein the information about the sensor includes at least one information item selected from: a last known location of the sensor; a destination location for the sensor; an intended path of travel for the sensor; or a location of an access point or base station used for communication with the sensor.

8. The method of claim 1, wherein the using the image data comprises comparing the image data with data from a database to replace the sensor data.

9. The method of claim 1, wherein the sensor that has failed is a tilt sensor, and wherein the using the data compares an angle of objects within the image data with a database image having the same objects.

10. The method of claim 1, further comprising, after receiving the indication, sending a trigger to a sensor apparatus requesting the image data.

11. A computing device configured for replacing sensor data from a sensor that has failed, the computing device comprising:
a processor; and
a communications subsystem,
wherein the computing device is configured to:
receive an indication that the sensor has failed;
receive image data from a location associated with the sensor; and
use the image data to replace sensor data from the sensor that has failed.

12. The computing device of claim 11, wherein the computing device is a server, and wherein the sensor is on a remote sensor apparatus reporting to the server.

13. The computing device of claim 11, wherein the sensor that has failed is a positioning sensor, and wherein the computing device is configured to use the image data by identifying location data within the image data.

14. The computing device of claim 13, wherein the location data is at least one data item selected from the group including street name information; landmark information; monument information; or building information.

15. The computing device of claim 11, wherein the sensor that has failed is a positioning sensor, and wherein the image data is compared to a database of images correlated to location data.

16. The computing device of claim 15, wherein the images in the database used for comparing are narrowed based on information about the sensor.

17. The computing device of claim 16, wherein the information about the sensor includes at least one information item selected from: a last known location of the sensor; a destination location for the sensor; an intended path of travel for the sensor; or a location of an access point or base station used for communication with the sensor.

18. The computing device of claim 11, wherein the computing device is configured to use the image data by comparing the image data with data from a database to replace the sensor data.

19. The computing device of claim 11, wherein the sensor that has failed is a tilt sensor, and wherein the computing device is configured to use the data by comparing an angle of objects within the image data with a database image having the same objects.

20. The computing device of claim 11, wherein the computing device is further configured to send a trigger to a sensor apparatus requesting the image data after receiving the indication.

21. A computer readable medium for storing instruction code, which, when executed by a processor of a computing device configured for replacing sensor data from a sensor that has failed, causes the computing device to:
receive an indication that the sensor has failed;
receive image data from a location associated with the sensor; and
use the image data to replace sensor data from the sensor that has failed.
